(19) United States
(12) Patent Application Publication
(10) Pub. No.: US 2021/0035073 A1
(43) Pub. Date: Feb. 4, 2021

(54) Multi-Party Digital Check

(71) Applicant: Pankaj Gupta, FREMONT, CA (US)

(72) Inventor: Pankaj Gupta, FREMONT, CA (US)

(21) Appl. No.: 16/942,747

(22) Filed: Jul. 29, 2020

Related U.S. Application Data
(60) Provisional application No. 62/880,049, filed on Jul. 29, 2019.

(51) Int. Cl. G06Q 20/04; G06Q 40/00; G06Q 20/10; G06Q 20/40

(52) U.S. Cl. CPC G06Q 20/042; G06Q 40/128; G06Q 20/405; G06Q 20/4014; G06Q 20/4037; G06Q 20/108

(57) ABSTRACT

Exemplary embodiments provide a multi-party digital check (MP-DC) through an electronic payment system that captures payor payment data/metadata regarding the intended multiple payees. The current embodiment shows two distinct payees, however the system is scalable to more than two distinct payees. MP-DC could have originated from a paper check as a facsimile picture or could be computer generated. The MP-DC is delivered to both payees via an online channel such as email, phone text message, in app message or any other form of online communication. In the current embodiment either Payee can endorse the MP-DC completely online with it's online signature or equivalent unique key i.e. without printing out the check. Once a payee has endorsed the MP-DC the other payee gets an online notification presenting the second payee with a MP-DC. The second payee has the option to cash the MP-DC using one of the methods/options presented. In the current embodiment, available options are printing the check, adding bank account information for ACH or Check21 deposit, adding debit card information for “push to card” transaction or receiving a Virtual or Physical Debit or Credit with balance equal to the amount on the original check.

### REFERENCE TO RELATED APPLICATIONS

This application claims priority to U.S. Provisional Application No. 62/880,049 filed on Jul. 29, 2019 entitled MULTI-PARTY DIGITAL CHECK to Inventor Pankaj Gupta, the entirety of which is herein incorporated by reference in its entirety.

### BACKGROUND

The subject matter herein relates to the technical field of payments. More particularly, the subject matter is in the technical field of digital payments.

The checking infrastructure constitutes a robust and established means of transferring payments. One perceived drawback to paper checks remains the relative difficulty of transacting them online. Nonetheless, the infrastructure carries some structural advantages over other forms of payments, resulting in over 15 billion annual check payments.

### BRIEF SUMMARY OF THE INVENTION

Illustrative embodiments include using a Digital Check for multi-party use. Multi-party use is defined as a Digital Check made in favor of more than one Payee, i.e. payable jointly to more than one payee. The number of payees could vary but is typically limited to 2. A common use of such payments is payouts for insurance claims, where there is a lien holder for the property e.g. a payment for a car accident where the Digital Check is made out to the vehicle owner as well as the lienholder on the vehicle. For the vehicle owner to cash the Digital Check it must be endorsed by the lien holder. Alternately the vehicle owner can endorse the Digital Check to the lien holder for payment that could be applied toward the outstanding loan.

This application defines the process of creation and processing of a Multi-Party Digital Check in a way that the entire process is online i.e. endorsement and cashing of the Digital Check is done completely online, without the need to print out any Checks on paper.

Described is a fully digital means of sending and receiving Multi-party Digital Checks along the existing checking infrastructure. The concept of the check being “digital” allows consumers to easily transfer funds via web, email, or mobile device. A Multi-party Digital Check is unique among payment solutions in that it may be printed and converted into a paper check at any point within the payment process, which allows for the transfer of funds in an online to offline fashion if needed. The “multi-party” aspect of the described payment solution allows consumers to write the Digital Check to multiple recipients, although in most cases the number of recipients is limited to 2. One recipient endorses the check through a fully digital process. Once this is successfully done, the other recipient can easily deposit the check online, or as mentioned previously, print the check and deposit it through their mobile banking app.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 shows a Multi-Party Digital Check functionality in accordance with an illustrative embodiment.

FIG. 2 shows an illustrative embodiment of an email sent to both recipients of the multi-party check specified in FIG. 1.

FIG. 3 shows an illustrative embodiment of an endorsement page that can be reached through the email in FIG. 2.

FIG. 4 shows an illustrative embodiment of an endorsement box that appears after clicking the endorse option in FIG. 3.

FIG. 5 shows an illustrative embodiment of a page that the endorser is redirected to after successfully endorsing the check.

FIG. 6 shows an illustrative embodiment of a deposit page that is reached through the other recipient's email from FIG. 2.

FIG. 7 is an illustrative diagram of the check flow from the recipient side from endorsement to deposit

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The following description is presented to describe an illustrative system for sending and receiving Multi-party Digital Checks.

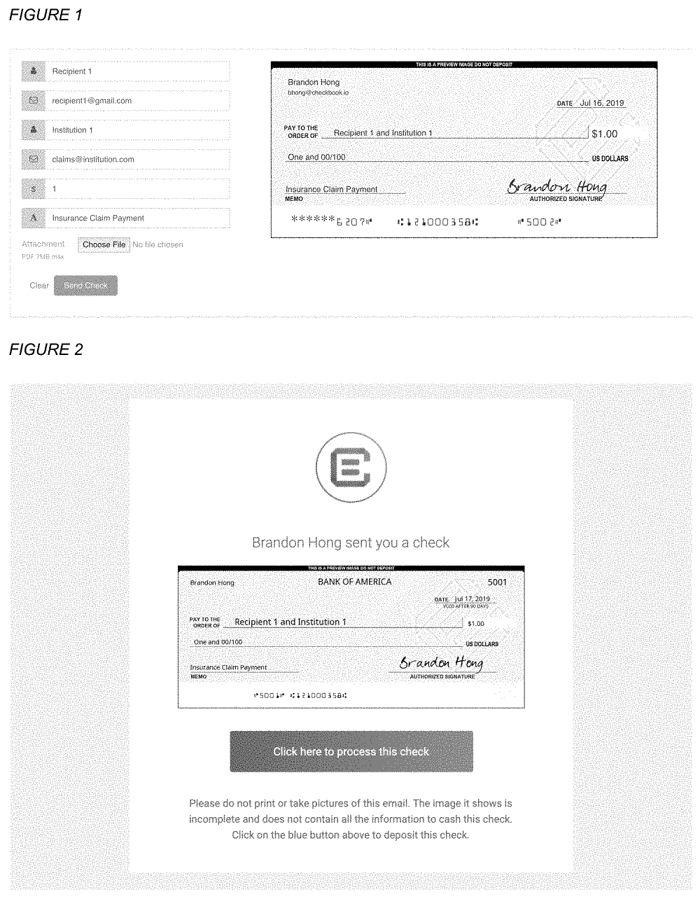

FIG. 1 illustrates an illustrative example of a Multi-party Digital Check interface on a digital checkbook platform. In order to send a Multi-party Digital Check, the payor fills in the required fields, which include ‘Payee one's name,’ ‘Payee one's email address,’ ‘Payee two's name,’ ‘Payee two's email address,’ ‘Amount,’ and an optional ‘Description’ field. The payor also has the option to attach a file to provide further details regarding the payment.

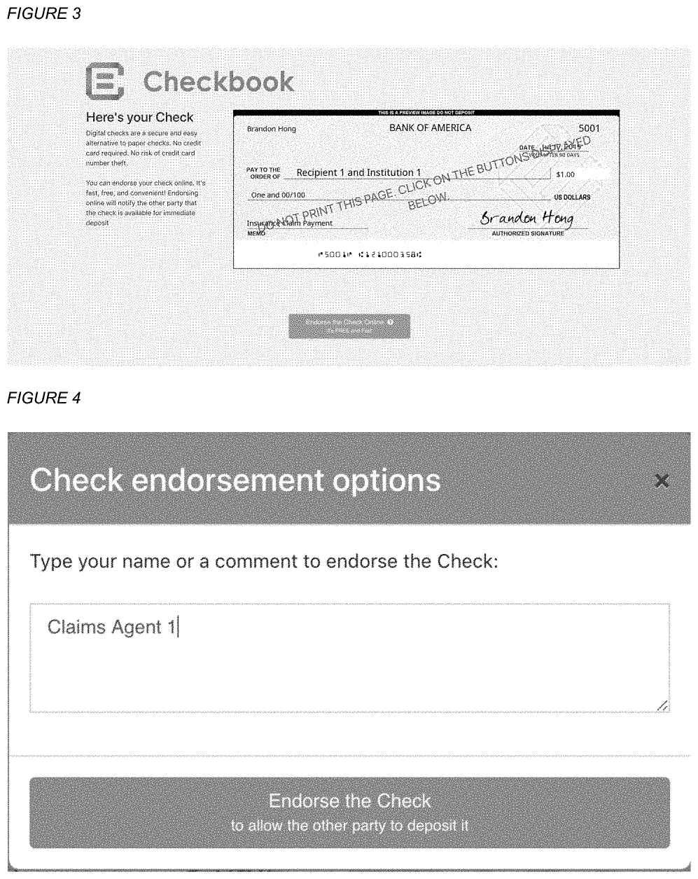

FIG. 2 represents an example of an email that may show up in the inbox of both payees after the payor has completed all the required information in FIG. 1 and sent the Multi-party Digital Check. As pictured below, the email displays an image of the Digital Check and a link to process the check. The deposit process may involve one payee endorsing the Digital Check, which then notifies the other payee that the Digital Check is available for deposit. A common use of such payments is payouts for insurance claims, where there is a lien holder for the property e.g. a payment for a car accident where the Digital Check is made out to the vehicle owner as well as the lienholder on the vehicle. For the vehicle owner to cash the Digital Check it must be endorsed by the lien holder. To endorse the Digital Check, the designated payee simply clicks on the ‘Click here to process this check’ link, which directs the payee to the page shown in FIG. 3.

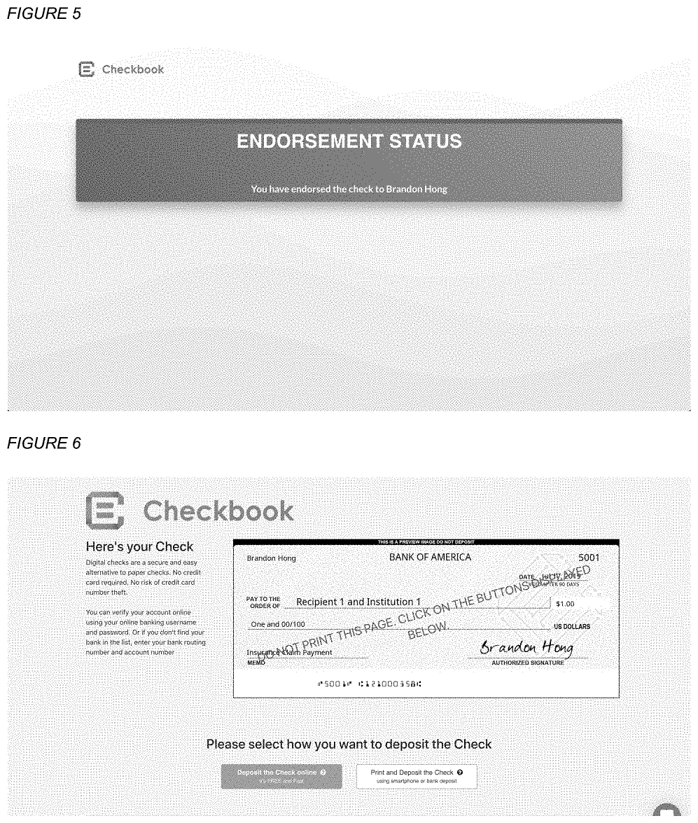

FIG. 3 represents an illustrative example of a page that the payee is directed to after selecting the ‘Click here to process this check’ option on the initial email that is sent out to both payees. The page displays an image of the Digital Check, made out to both payees with the correct amount designated by the payor through the information entered in FIG. 1. Below the Digital Check, there may be a ‘Click here to endorse this check’ button, which the designated payee should click in order for the check to be endorsed. Clicking the button prompts a pop-up to appear, allowing the user to type in their name and endorse the check. The pop-up that appears is illustrated in FIG. 4. As shown, the payee simply types in their name and clicks the ‘Endorse the Check to allow the other party to deposit it’ button. When the check has been successfully endorsed, the payee is redirected to the page shown in FIG. 5, which tells the first payee that the check has been endorsed to the other payee.

When the check is endorsed by the designated payee through the flow described with FIG. 3 and FIG. 4, the other payee can then deposit the check through the same email that was received originally, represented in FIG. 2. However, instead of taking the payee to the endorsement page, the ‘Click here to process this check’ link takes the payee to the deposit page as displayed in FIG. 6. In addition to the Digital Check displayed on the page, the deposit page also includes 2 deposit options for the payee to select from. Option 1 involves depositing the check automatically online, which requires the payee to create an account on, for example a digital checkbook website if he or she does not already have one. The payment will arrive as an ACH credit within 2 business days following the option 1 deposit method. Option 2 is to print the check and deposit it using mobile deposit through the payee's smartphone banking app, in which the funds will be received in the usual time allotted for a mobile check deposit.

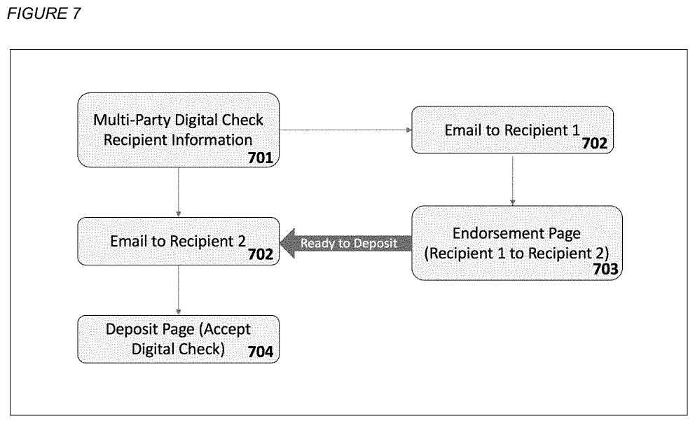

FIG. 7 provides an illustrative example of the check flow described above. Box 701 refers to FIG. 1, where the sender fills out the recipient and check information for the Multi-Party Digital Check that the sender wishes to send out. The 702 boxes represent the email shown in FIG. 2 that appears in the inboxes of both recipients after the check is sent. In the diagram, recipient 1 accesses box 703, which is the endorsement page described in FIG. 3. There, the recipient follows the endorsement process described in relation to FIG. 4 and FIG. 5. When the check has been endorsed by recipient 1, recipient 2 can then deposit the check through the same email represented by box 702 and FIG. 2. The email takes recipient 2 to box 704 or FIG. 6, where he or she is able to deposit the check through either of the 2 methods described above: online deposit or mobile banking deposit.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

What is claimed is:

1. A paperless check method, comprising:
providing, by a server, the payor a set of options to create a multi-party digital check through an electronic interface;
receiving, by the server, from the payor input information required to create the multi-party digital check;
generating the multi-party digital check by one of taking an image of a paper check created using the information provided by the payor or a generating a computer image of the check;
providing the payor ability to input identification information for at least two distinct payees;
receiving from the payor of the multi-party digital check an amount payable, a date of issuance, payor bank information, and a signature or online authorization of the payor; and
capturing metadata and associated log information for the multi-party digital check.

2. The method of claim 1, further comprising:
providing the payor a set of relevant warranties and indemnities applicable to the banks of first deposit and the clearing banks, should the multi-party digital check be used as a paper check.

3. The method of claim 1, further comprising
providing by the payor online identifiers for each payee.

4. The method of claim 3, wherein the online identifier includes at least one of the payee's email address, phone number, and social media profile identifier.

5. The method of claim 1, further comprising:
creating a multi-party digital check based on the information provided by the payor.

6. The method of claim 1, further comprising:
notifying the payor and the payee of the multi-party digital check, either immediately or following a certain time interval.

7. The method of claim 1, wherein the steps are at least partially executed on an electronic payment computer system connected to a network.

8. The paperless check method of claim 1, further comprising:
authenticating the payor's identity and bank account information online.

9. The method of claim 8, wherein authenticating includes at least one of making micro-deposits to the payor's bank account and asking the payor to verify those deposits, and interactive bank account verification using the bank's API or connecting to the bank's online banking portal online.

10. The method of claim 1, further comprising:
Providing payment instructions including any of conditions, limitations, restrictions, and conditional acknowledgements comprising business rules governing payment terms.

11. The method of claim 1, further comprising:
tracking information that is operable to provide an audit history of the digitally originated check and to provide the payor and payees access to this history.

12. The method of claim 1, further comprising:
printing a substitute check from the metadata, wherein the substitute check is printed with zero degrees of skew and with substantially no stray noise.

13. The method of claim 1, further comprising:
VOIDING the digitally originated check through the computer system, wherein the VOIDING is performed immediately as long as the multi-party digital check has not yet been accepted by or actioned by any of the payees.

14. The method of claim 1, further comprising:
utilizing a positive pay database to determine whether the digitally originated check is valid prior to payment, should any of the payees decide to recreate the original paper check from the multi-party digital check.

15. The method of claim 1, further comprising:
providing the ability of any of the payees of the multi-party digital check to be able to endorse the original check to one or more of the other payees

16. The method of claim 1, further comprising:
providing the ability of the last payee to cash the multi-party digital check using one of the multiple possible options made available to the last payee once all the payees other than one leftover payee have endorsed the multi-party digital check to the last payee.

17. The method of claim 16, wherein the possible options include at least one of:
printing out the multi-party digital check;
depositing the multi-party digital check online by payee verifying their bank account interactively or manually and optionally providing additional identification information;
depositing the multi-party digital check online by payee by inputting their Debit Card number issued by VISA or Mastercard or another card issuing authority and funds being transferred from the payor's account to the payee's account using one or more payment networks; and
converting the multi-party digital check into a Virtual Card i.e. a Debit or a Credit Card issued by VISA or Mastercard or another card issuing authority, the Virtual Card configured to have a prepaid balance equal to the amount on the original multi-party digital check.
